(19) United States
(12) Patent Application Publication
(10) Pub. No.: US 2008/0096493 A1
(43) Pub. Date: Apr. 24, 2008

(54) Communication device for rock climbing and the like

(76) Inventor: Jason Kerwood, Boulder, CO (US)

Correspondence Address: EMERY L. TRACY, P.O. BOX 1518, BOULDER, CO, 80306, US

(21) Appl. No.: 11/893,218

(22) Filed: Aug. 14, 2007

Related U.S. Application Data
(60) Provisional application No. 60/853,342, filed on Oct. 20, 2006.

(51) Int. Cl. H04B 1/38; A44B 21/00; H02G 11/02

(52) U.S. Cl. 455/90.2; 191/12.4; 24/489; 455/90.3

(57) ABSTRACT

A communication device for rock climbers and the like is provided. The communication device comprises an outer casing and a plastic insert mounted within the outer casing. Communication electronics are mounted within the plastic insert. An earbud is connected to the communication electronics and seatable in an opening in the outer casing with the earbud having an easy grab protrusion extending beyond the opening. A retraction mechanism connects the earbud for extending and retracting the earbud into the opening. A releasable closure mechanism is secured to the outer casing for securing the communication device to, and releasing the communication from, an object.

The present application claims priority of pending provisional patent application Ser. No. 60/853,342, filed on Oct. 20, 2006, entitled “Rock Climbing Oriented Communication Device”.

### BACKGROUND OF THE INVENTION

1. Field of the Invention

This invention relates generally to equipment used to make rock climbing and other similar activities safer and, more particularly, the present invention relates to a communication device for rock climbing and the like for providing safer climbing by improving the methods in which climbing partners communicate. This invention can also be used in a variety of activities where hands-free, voice activated communication is desired.

2. Description of the Prior Art

Climbing is a unique, exciting, and challenging endeavor. However, even in the best of conditions, numerous variables exist which result in an inherent risk of serious injury or even death. The goal of any climber—novice or experienced—is to minimize the number of uncontrollable variables by planning for as many different aspects of an outing before departure. This includes bringing the correct amount of food, water, gear, etc. Whether consciously or unconsciously, all successful climbers do this process of preemptive planning in order to both increase the chance of success and decrease the possibility of serious injury.

One such aspect of an outing that has not yet been adequately identified is that of communication. Communication not only has the potential to affect the success of the climb but also the safety of both climbers. Most experienced rock climbers that use ropes will agree that when separated by as short of a distance as one rope length, the ability to communicate with your partner drops to nearly zero. While verbal communications may work in some situations, the commonly used method of communication between climbing partners is accomplished primarily by tugging on the rope.

Unfortunately, tugging on the rope is an extremely unreliable and difficult to interpret method of communication. Was that two tugs or three tugs? Did four tugs mean belay on or belay off? Do they need slack? Was that one long tug or two short tugs? These questions can never be answered with certainty solely from the tug of a rope, and an incorrect interpretation could result in death.

The possibility of such a serious consequence due to lack of communication is something that should be unacceptable to the average climber. With today's technological advances in the communication industry, specifically in wireless communications and walkie-talkies, one must ask why climbers do not take advantage of these valuable resources. The answer is clear: no communication device has ever been specifically designed for the use of rock climbing and other similar climbing activities.

Current hand held walkie-talkies are not a viable option for climbers for several reasons. The most obvious is that current communication devices cannot be safely operated during many climbing activities. For example, when belaying or climbing, it is necessary to have both hands free in order to perform each activity safely. Another reason is that current communication devices cannot be easily operated while being clipped to a harness or gearsling, thus creating an inherent risk of dropping and losing the device while on a rock face.

### SUMMARY

The present invention is a communication device for rock climbers and the like. The communication device comprises an outer casing and a plastic insert mounted within the outer casing. Communication electronics are mounted within the plastic insert. An earbud is connected to the communication electronics and seatable in an opening in the outer casing with the earbud having a protrusion extending beyond the opening. A retraction mechanism connects the earbud for extending and retracting the earbud into the opening. A releasable closure mechanism is secured to the outer casing for securing the communication device to, and releasing the communication device from, an object.

### BRIEF DESCRIPTION OF THE DRAWINGS

FIG. 1 is a perspective view illustrating one embodiment of a communication device for rock climbing and the like, constructed in accordance with the present invention, with the communication device being substantially carabiner in shape and only slightly larger in size and a retractable earbud and microphone system allowing hands free, voice activated communication between climbing partners;

FIG. 2 is a perspective view illustrating an outer casing of the communication device for rock climbing and the like, constructed in accordance with the present invention;

FIG. 3 is a perspective view illustrating a plastic insert of the communication device for rock climbing and the like, constructed in accordance with the present invention, for insulating and protecting between the outer casing and the internal components;

FIG. 4 is a perspective view illustrating a climber interface system configuration of communication device for rock climbing and the like, constructed in accordance with the present invention, with an earbud and microphone system;

FIG. 5 is a perspective view illustrating another part of the climber interface system configuration of communication device for rock climbing and the like, constructed in accordance with the present invention, with a push-button retractor mechanism;

FIG. 6 is a front perspective view illustrating another embodiment of the communication device for rock climbing, constructed in accordance with the present invention;

FIG. 7 is a rear perspective view illustrating the communication device for rock climbing of FIG. 6, constructed in accordance with the present invention, with the earbud in an extended position;

FIG. 8 is another front perspective view illustrating the communication device for rock climbing of FIG. 6, constructed in accordance with the present invention;

FIG. 9 is a elevational front view illustrating the communication device for rock climbing of FIG. 6, constructed in accordance with the present invention, with the earbud in a retracted position;

FIG. 10 is another elevational front view illustrating the communication device for rock climbing of FIG. 6, constructed in accordance with the present invention, with the earbud in an extended position;

FIG. 11 is elevational rear view illustrating the communication device for rock climbing of FIG. 6, constructed in accordance with the present invention, with the earbud in a retracted position;

FIG. 12 is another elevational rear view illustrating the communication device for rock climbing of FIG. 6, constructed in accordance with the present invention, with the earbud in an extended position;

FIG. 13 is an elevational left side view illustrating the communication device for rock climbing of FIG. 6, constructed in accordance with the present invention, with the earbud seated within the communication device;

FIG. 14 is another elevational left side view illustrating the communication device for rock climbing of FIG. 6, constructed in accordance with the present invention, with the earbud and the wiregate carabiner attachments removed from the drawing;

FIG. 15 is an elevational right side view illustrating the communication device for rock climbing of FIG. 6, constructed in accordance with the present invention;

FIG. 16 is a perspective view illustrating the communication device for rock climbing of FIG. 6, constructed in accordance with the present invention; and

FIG. 17 is a flow chart illustrating a family of products for the communication device for rock climbing.

### DETAILED DESCRIPTION OF THE PREFERRED EMBODIMENTS

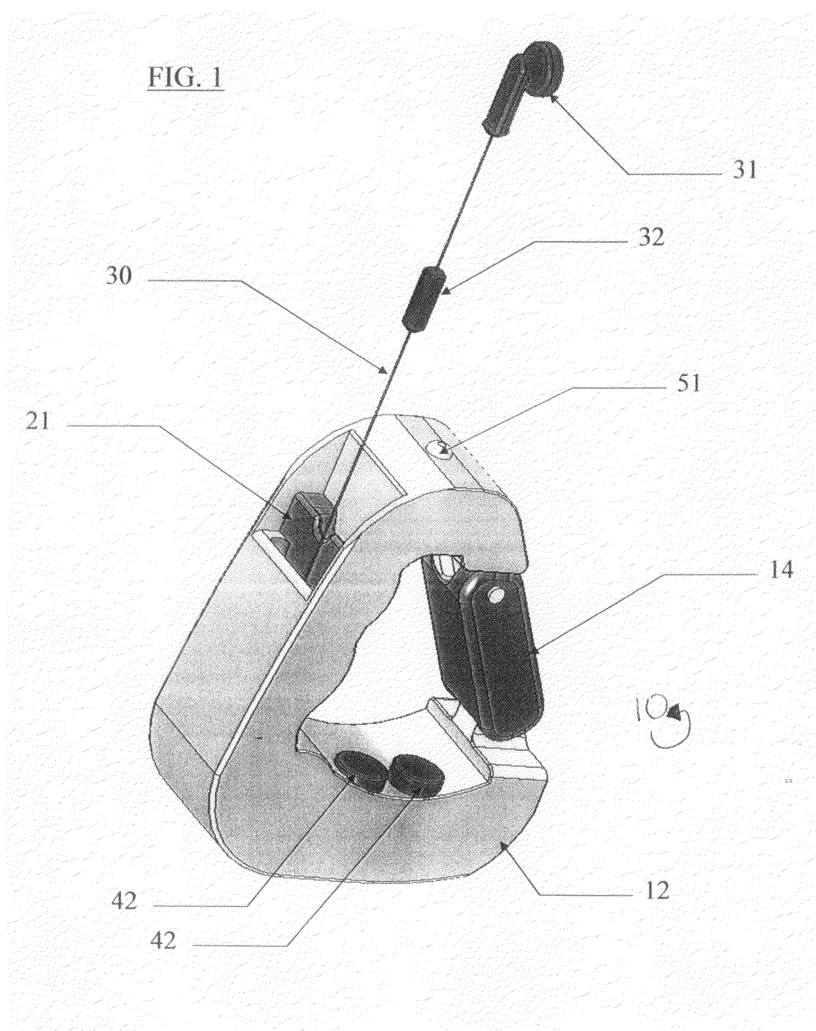

As illustrated in FIGS. 1-4, the present invention is a climbing oriented communication device, indicated generally at 10, for use in improving communication methods between climbing partners. In the present invention, each element of the communication device 10 will be described first.

FIG. 1 illustrates the communication device 10 of the present invention having an outer casing 12, gate 14, climber interface system 30 (comprised of earbud 31 and microphone 32 system combined with a retractor mechanism 33), plastic insert 21 to house internal components and store climber interface system 30, operational dials 42, and optional LED 51 to indicate on/off status. Not seen in FIG. 1 are the internal components such as electronics and batteries, as well as the button used to control the retraction of the climber interface system 30. Also not shown are the internal speaker and microphone used when the communication device 10 is oriented as a hand-held walkie-talkie.

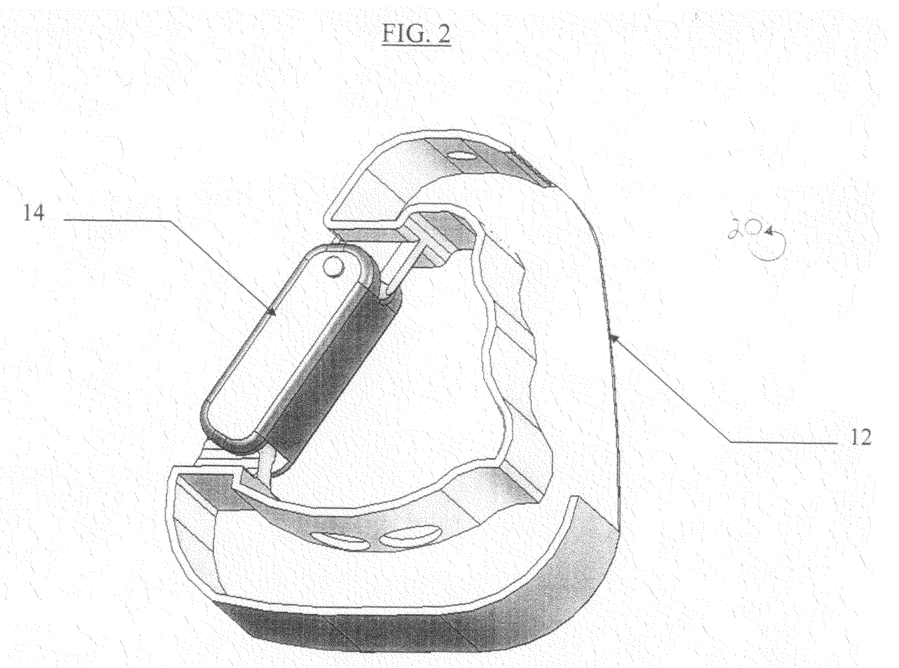

FIG. 2 illustrates the outer casing 12 and gate 14, indicated generally at 20, of the communication device 10 of the present invention used for maintaining the carabiner shape and provide functionality. The carabiner shape will be relatively familiar to the average climber and promote a secure, convenient, and trusted attachment. The specific dimensions of the outer casing 12 will be determined by housing requirements for the climber interface system 30 and internal components (not shown). The durability standards of the communication device 10 require that the unit must maintain functionality while enduring the common abuse associated with being placed on a harness or gearsling during a climb. This condition implies that (i) the outer casing 12 will most likely be constructed out of a lightweight, durable metal such as aluminum or titanium although constructing the outer casing 12 from other materials, such as plastic, is within the scope of the present invention and (ii) the case will include various seals and devices to be water, dust, and shock resistant.

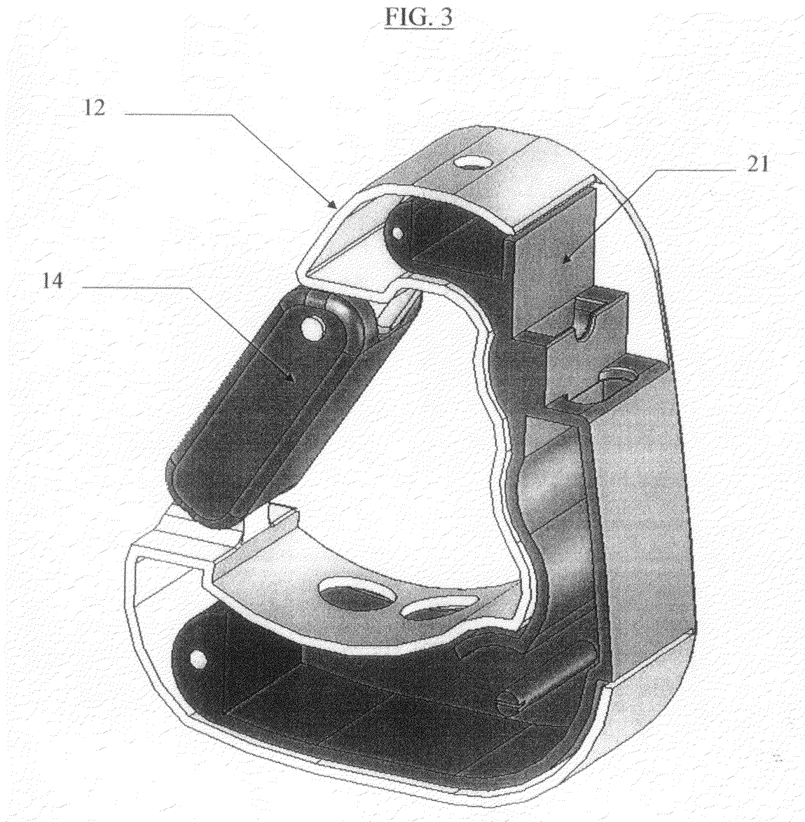

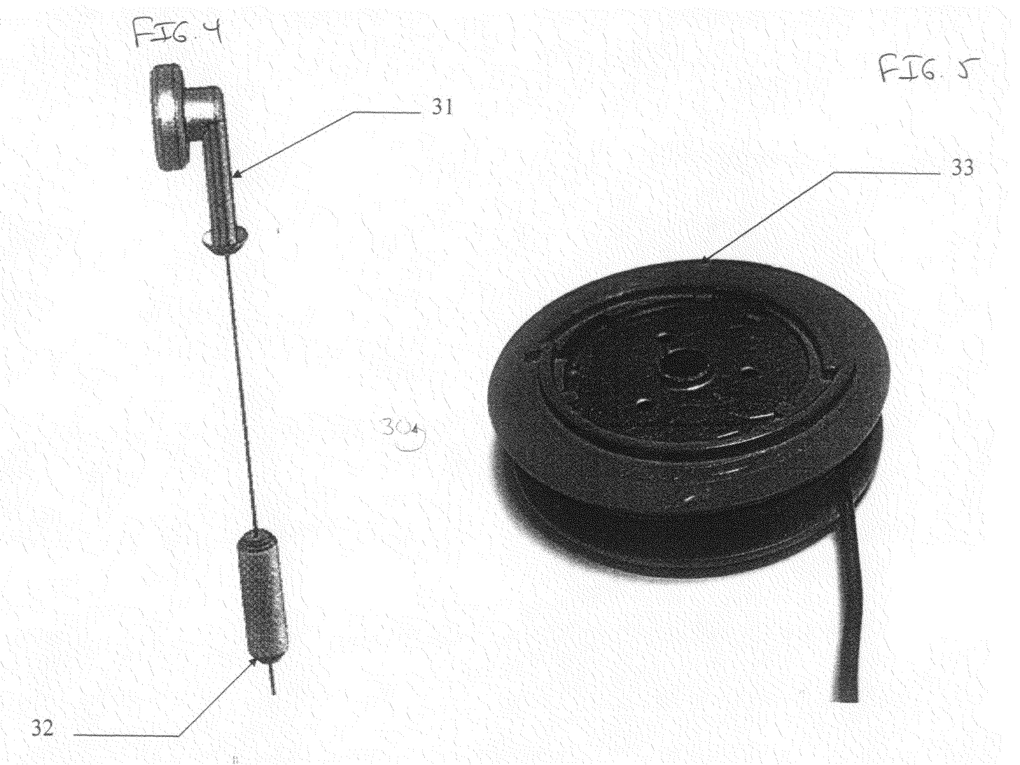

As illustrated in FIG. 3, the outer casing 12 of the communication device 10 surrounds an example of a plastic insert 21. This plastic insert 21 provides insulation and protection between the outer casing 12 and the internal components. The plastic insert 21 houses the climber interface system 30, electronic components, and batteries.

As illustrated in FIG. 4, a climber interface system 30 is provided. The climber interface system 30 has an earbud 31 and microphone 32 system allowing for hands free, voice activated communication between climbing partners. Preferably, the earbud 31 has a built-in, easy-grab, shark fin shaped appendage attached to or formed in the earbud 31 for quick and easy access. The climber interface system 30 combines with a spring loaded spool retractor mechanism 33 for quickly and conveniently storing the system while not in use.

The operation of a communication device 10 of the present invention will now be described. A person skilled in the art will understand that the communication device 10 can be operated in numerous manners and that the description set forth below is merely one manner of operation.

The communication device 10 of the present invention is powered on by using operational dials 42. The power supply is indicated by the LED 51 located on the top. Using operational dials 42, the user sets their volume level preference and designates a common channel of communication. While the climber interface system 30 is retracted into its protective recess, located on the plastic insert 21, the communication device 10 has the ability to function as a hand-held walkie-talkie by utilizing a built in microphone and speaker system (not shown). The communication device 10 is attached to the lead climbers harness or gear sling and secured by the gate 14.

While the communication device of the present invention 10 proves useful for communication during the actual movement of climbing, the communication device 10 will probably be needed most when a climber transitions from the person who is climbing to become the person who is belaying. It is during this period that climbing partners are separated by as much distance as one rope length and will have to perform a variety of transition related tasks that often require the use of both hands. With verbal and visual communications severely limited, the ability to communicate clearly becomes extremely difficult.

At this point, the lead climber employs the communication device 10 of the present invention by grabbing and pulling the earbud 31 of the climber interface system 30 from its protective recess. The earbud 31 is comfortably and securely placed in the climber's ear of choice. Once the earbud 31 and microphone 32 are pulled from their protective recess, the communication device 10 automatically changes from a hand-held walkie-talkie to a hands-free, voice activated communication device. A simple simultaneous push of operational dials 42 will serve as the “Call” feature and notify one climbers need to talk to the other. When utilizing this climber interface system 30, the user simply has to speak clearly into the microphone 32 and listen through the earbud 31 speaker. In this manner, a climber will be able to accurately and consistently know the condition and status of their partner, thus improving the overall safety of the climb.

When the climber no longer needs to communicate with their partner, a button will be pushed to enable the retractor mechanism 33 and pull the climber interface system 30 back into its protective recess until future use is desired. Operational dials 42 will be used to power off the communication device 10.

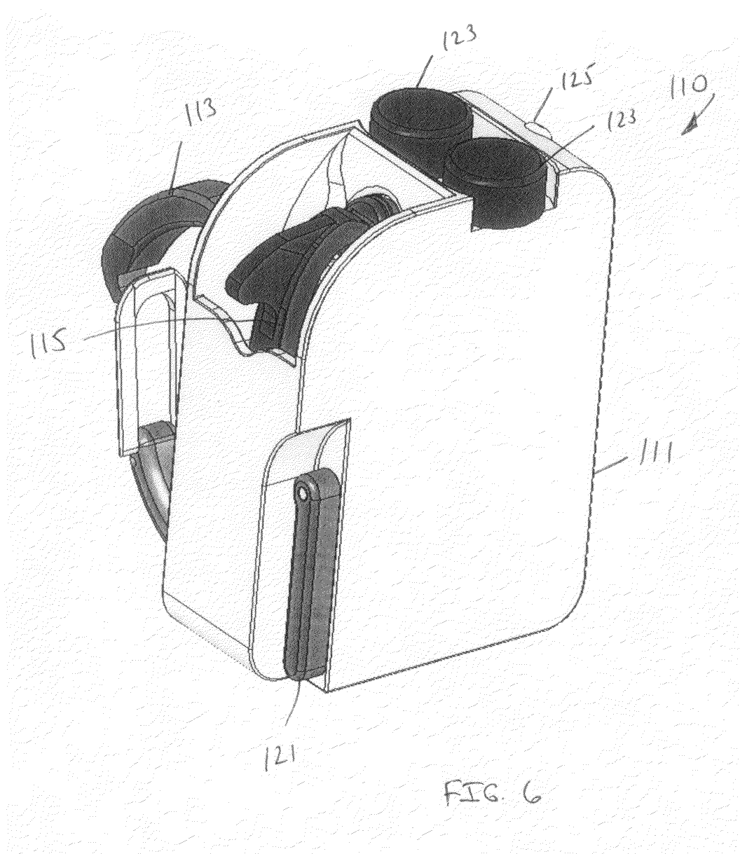

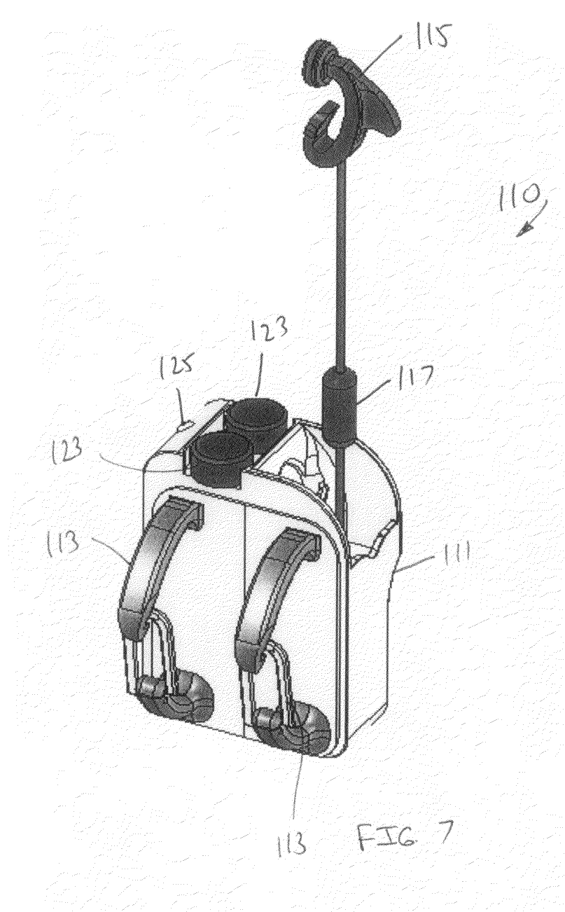

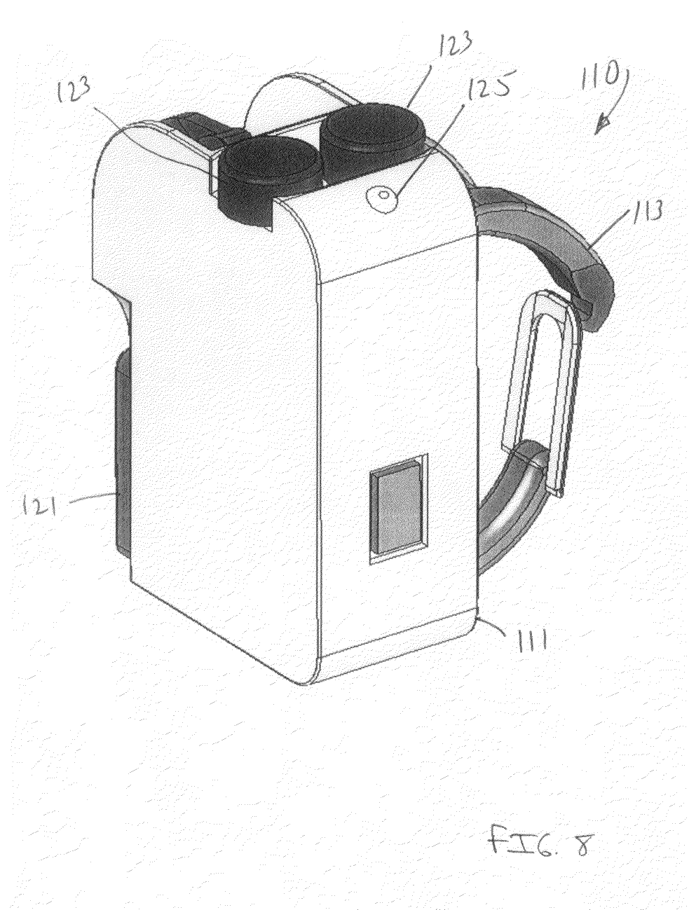

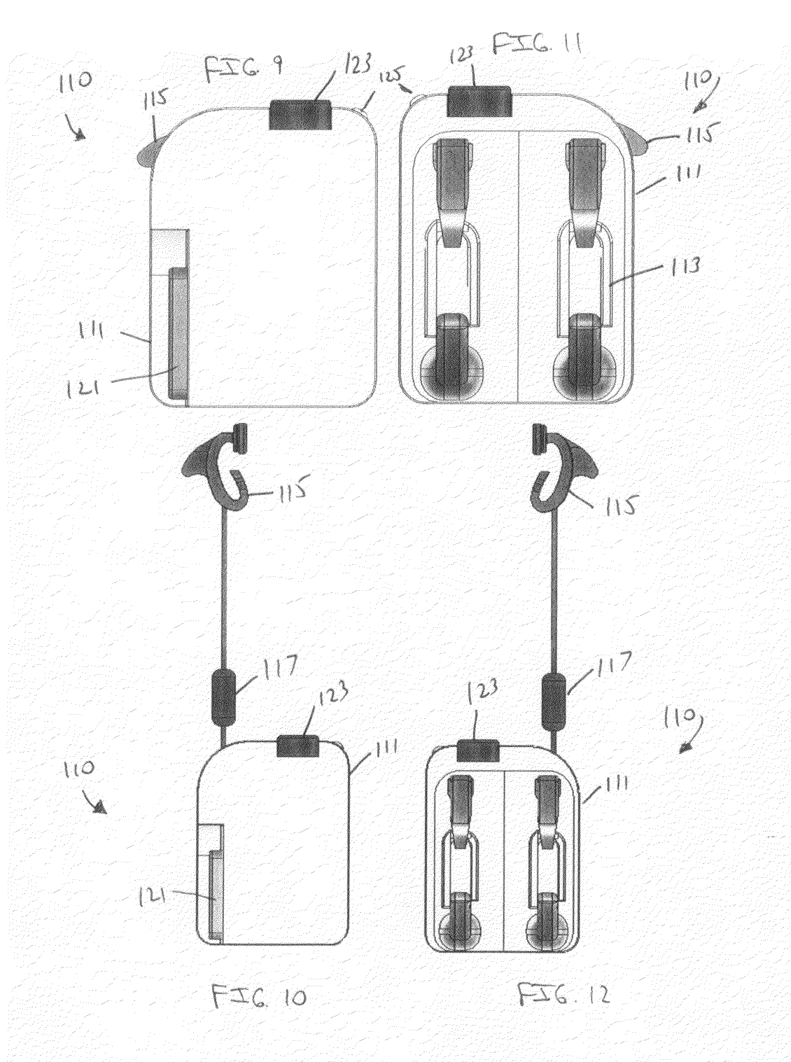

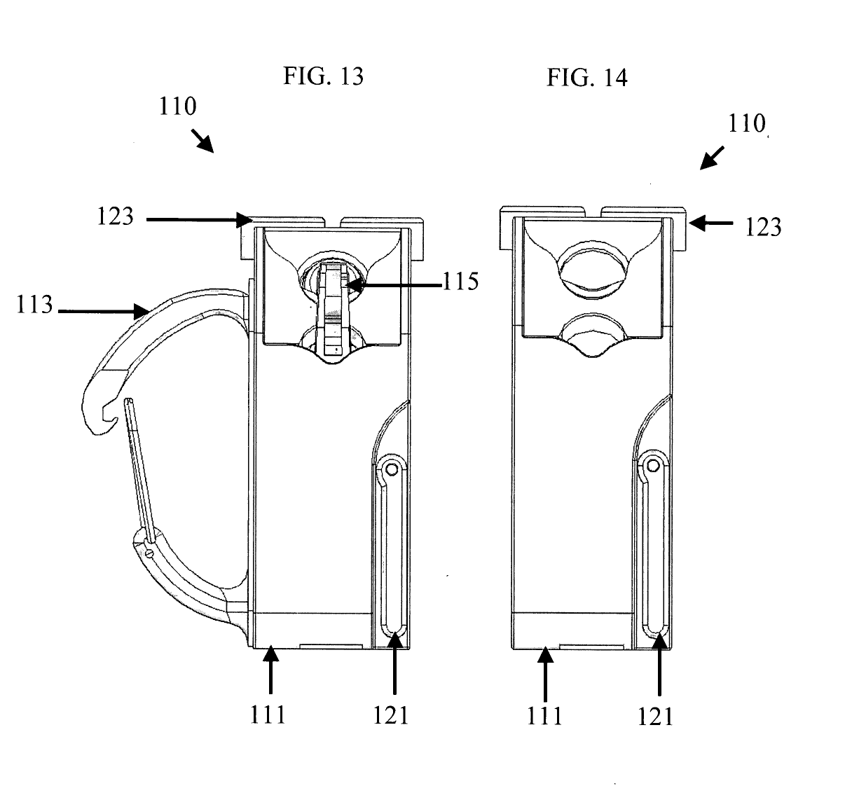

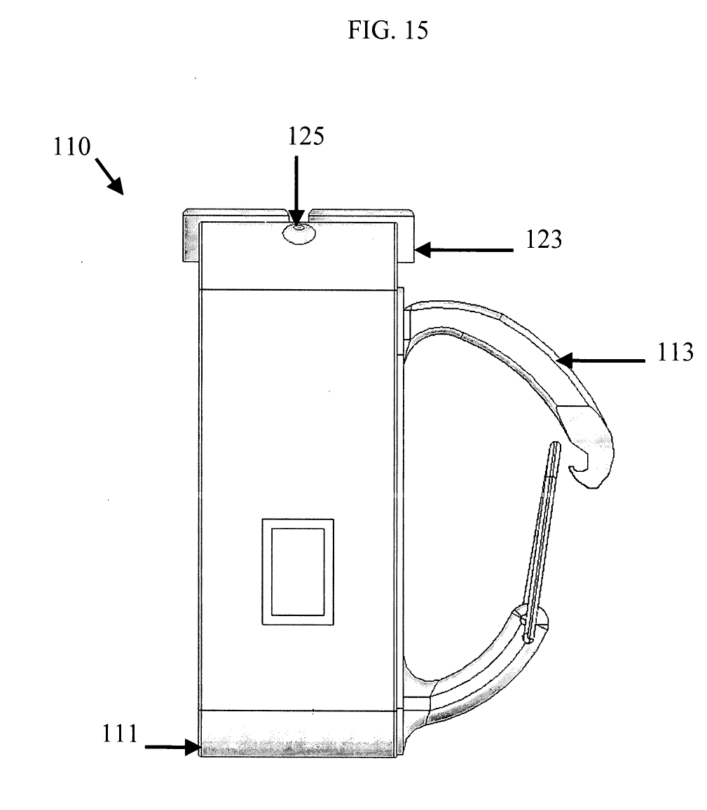

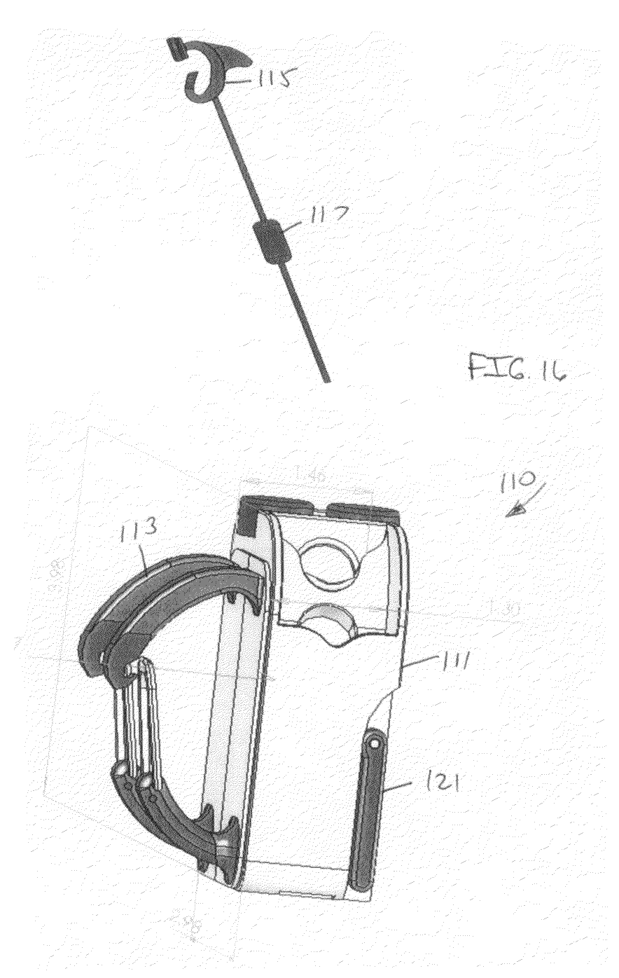

As illustrated in FIGS. 6-16, in another embodiment of the present invention is the communication device 110 comprises a durable plastic and metal box 111 integrated with dual wiregate carabiner attachments 113 combined with a built-in, easy-grab, shark fin shaped retractable earbud 115 and microphone 117. The communication device 110 of this embodiment provides secure attachment as well as continually maintaining the orientation of the communication device 110 relative to a harness or gearsling. By attaching each wiregate carabiner clip 113 to adjacent gear loops, the communication device 110 automatically and continuously faces in the desired, upright manner.

The dual gates 113 of the communication device 110 of the present invention ensure that the communication device 110 has restricted horizontal and vertical motion along a harness or gearsling. The stable and consistent orientation provided by the communication device 110 is convenient and ultimately easier to use, both of which are important to the average climber. In one instance, the user can attach each wiregate carabiner 113 to adjacent gear loops, causing the communication device 110 to be positioned in the space between the two loops. This positioning helps to allow adequate room for other pieces of climbing equipment as well as ensure that the communication device 110 is as least intrusive as possible.

When not in use, the earbud 115 and microphone 117 are adequately protected from abrasions and stresses by the outer casing 111 of the communication device 110. Having both operational dials 123 partially recessed on the top of the communication device 110 provides protection to the dials while allowing easy operational access. In addition, the communication device 110 has a rotatable antenna 121 and is powered on by using the operational dials 123. Using operational dials 123, the user sets their volume level preference and designates a common channel of communication. The power supply is indicated by the LED 125 located on the top. All the features of the previous embodiment are incorporated into the communication device 110.

In sum, the present invention is a climbing oriented communication device 10, 110 designed to meet the unique communication needs of a rock climber. The communication requirements of a climber mandate a device that will provide hands-free, voice activated communication, a quick and secure method of attachment to a harness or gearsling, operational ability while attached to the harness or gearsling (i.e., the user does not have to remove it from the harness to use the device), and ruggedness to endure a variety of environments and stresses. A climber communication device will also need to be simple to use and reliable. The features of the communication device 10, 110 of the present invention satisfy these needs by including: (i) voice activated, hands free operation, (ii) operational ability while attached to a harness or gear sling, and (iii) durability designed to endure a variety of climbing environments.

Embodiments of the communication device 10, 110 of the present invention include a device that is either carabiner in shape, incorporating a carabiner-like figure and gate, or generally box shaped with appropriate carabiner or wiregate attachments to promote a secure and familiar attachment to a harness or gearsling. Other configurations are also possible. The carabiner-shaped communication device 10, 110 and corresponding gate is preferably slightly larger and thicker than the average carabiner and will preferably be constructed with a metal and plastic shell. This shell, coupled with the plastic insert, will house internal electronic components as well as provide protection to the unique, retractable climber interface system.

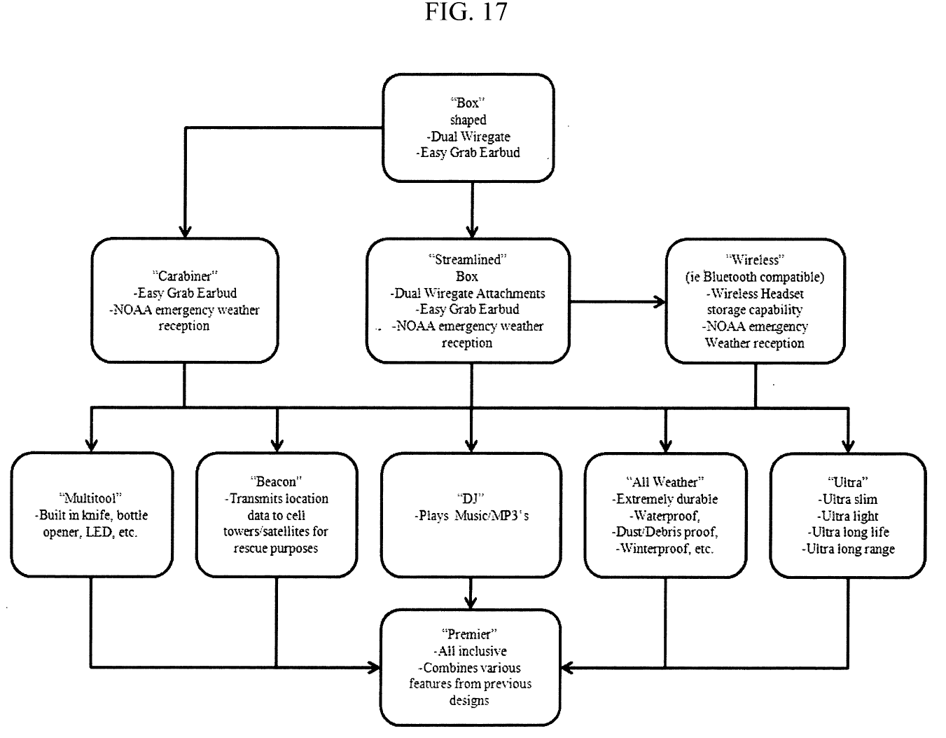

The aforementioned communication device 10, 110 configurations and features represent just a few possible designs. While continuing to fulfill the unique communication needs of the average climber, alternate embodiments of the communication device 10, 110 will provide new features and greater specialization. These designs will help to broaden the spectrum of capabilities that the communication device 10, 110 will provide in order to encompass as many different climbing conditions and situations as possible. Shown in FIG. 17 are just a few of the alternate communication device 10, 110 embodiments that will prove to be useful to a wide range of climbers.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. A communication device for rock climbers and the like, the communication device comprising:
an outer casing;
a plastic insert mounted within the outer casing;
communication electronics mounted within the plastic insert, the communication electronics providing hands-free communication;
an earbud connected to the communication electronics and seatable in an opening in the outer casing, the earbud having an easy grab protrusion extending beyond the opening;
retraction means connected to the earbud for extending and retracting the earbud into the opening; and
releasable closure means secured to the outer casing for securing the communication device to, and releasing the communication device from, an object.

2. The communication device of claim 1 wherein the retraction means further includes a button for retracting the earbud into the opening after the earbud has been extended.

3. The communication device of claim 1 and further comprising:
an internal speaker and microphone for using the communication device as a hand-held walkie-talkie.

4. The communication device of claim 1 wherein the outer casing has a substantially carabiner shape having a substantially triangular cross-sectional configuration, the outer casing having an outer surface and an inner surface, wherein when the outer casing is releasably secured to the object, the outer casing is oriented in a single direction only.

5. The communication device of claim 4 wherein the outer surface of the outer casing has an on/off indicator light, the indicator light facing in a generally upward direction.

6. The communication device of claim 4 wherein the inner surface of the outer casing has at least one operational dial for activating the communication electronics and adjusting the volume, each operational dial facing in a generally upward direction.

7. The communication device of claim 1 wherein the outer casing has a substantially rectangular cross-sectional configuration, the outer casing having a front surface, a back surface, and a top surface.

8. The communication device of claim 7 wherein the releasable closure means are mounted to the back surface of the outer casing.

9. The communication device of claim 7 wherein the top surface of the outer casing has an on/off indicator light and at least one operational dial for activating the communication electronics and adjusting the volume.

10. The communication device of claim 1 wherein the protrusion of the earbud is an arcuate appendage attached to or formed in the earbud, the arcuate appendage receiving being sized and shaped for receiving a digit of a hand.

11. The communication device of claim 1 wherein the retraction means includes a spring loaded spool retractor mechanism.

12. The communication device of claim 1 wherein the releasable closure means includes an automatic closure for maintaining the communication device on the object.

13. The communication device of claim 1 wherein the releasable closure means includes at least two, spring-loaded gates for restricting horizontal and vertical motion of the communication device.

14. A communication device for rock climbers and the like, the communication device comprising:
an outer casing;
communication electronics mounted within the outer casing, the communication electronics providing hands-free communication;
an earbud connected to the communication electronics and seatable in an opening in the outer casing, the earbud having an easy grab protrusion extending beyond the opening;
retraction means connected to the earbud for extending and retracting the earbud into the opening;
activation means for activating the communication electronics;
indicator means for indicating activation of the communication device, the indicator means facing in a substantially upward direction;
volume control means for controlling the volume, the volume control means facing in a substantially upward direction; and
releasable closure means secured to the outer casing for securing the communication device to, and releasing the communication device from, an object.

15. The communication device of claim 14 and further comprising:
an internal speaker and microphone for using the communication device as a hand-held walkie-talkie.

16. The communication device of claim 14 wherein the outer casing has a substantially carabiner shape having a substantially triangular cross-sectional configuration, the outer casing having an outer surface and an inner surface, wherein when the outer casing is releasably secured to the object, the outer casing is oriented in a single direction only.

17. The communication device of claim 14 wherein the outer casing has a substantially rectangular cross-sectional configuration, the outer casing having a front surface, a back surface, and a top surface.

18. The communication device of claim 14 wherein the protrusion of the earbud is an arcuate appendage attached to or formed in the earbud, the arcuate appendage being sized and shaped for receiving a digit of a hand.

19. The communication device of claim 14 wherein the retraction means includes a spring loaded spool retractor mechanism.

20. The communication device of claim 14 wherein the releasable closure means includes an automatic closure for maintaining the communication device on the object.
